(19) United States
(12) Patent Application Publication
(10) Pub. No.: US 2013/0018719 A1
(43) Pub. Date: Jan. 17, 2013

(54) ANALYZING EFFECTS OF ADVERTISING

(71) Applicants: Magid M. Abraham, Great Falls, VA (US); Harvir S. Bansal, Ontario (CA); Alan Vaughn, Reston, VA (US)

(72) Inventors: Magid M. Abraham, Great Falls, VA (US); Harvir S. Bansal, Ontario (CA); Alan Vaughn, Reston, VA (US)

(73) Assignee: COMSCORE, INC., Reston, VA (US)

(21) Appl. No.: 13/548,990

(22) Filed: Jul. 13, 2012

Related U.S. Application Data
(60) Provisional application No. 61/507,481, filed on Jul. 13, 2011.

(51) Int. Cl. G06Q 30/02

(52) U.S. Cl. 705/14.41

(57) ABSTRACT

One or more systems, processes, and models are provided to determine the effectiveness of different elements of an advertising campaign. Using the one or more systems, processes, and models, advertising effectiveness metrics are determined that indicate the relative effectiveness of the different elements of the campaign. A model may be generated by the system using information about the manner in which consumers are exposed to advertisements. The information, for example, can include a history of exposures to advertisements in the campaign that occur before a user submits input, such as a survey response. In addition, the information also can include a history of exposures to advertisements in the campaign that occur after the user submits input, such as a survey response. As a result, the effectiveness can be distributed across multiple exposures experienced by consumers rather than a single exposure.

### CLAIM OF PRIORITY

This application claims the benefit under 35 USC §119(e) to prior filed U.S. Provisional Patent Application Ser. No. 61/507,481, titled “Analyzing Effects of Advertising” filed on Jul. 13, 2011, which is herein incorporated by reference in its entirety for all purposes.

### BACKGROUND

In general, advertisers may want metrics that inform the advertisers about the effectiveness of a given advertising campaign. The advertisers may want to understand the advertising effectiveness across one or more different advertising effectiveness metrics, such as unaided awareness, recall, brand favorability, intent to purchase, and brand recommendation.

### SUMMARY

In one general aspect, a model is generated to indicate the effectiveness of different elements of an advertising campaign. Using the model, advertising effectiveness metrics are determined that indicate the relative effectiveness of the different elements of the campaign. The model is generated using information about the manner in which consumers are exposed to advertisements. For example, the information can include a history of exposures to advertisements in the campaign that occur before a user submits input, such as a survey response. In addition, the information also can include a history of exposures to advertisements in the campaign that occur after the user submits input, such as a survey response. As a result, the effectiveness indicated by a survey response can be distributed across multiple exposures experienced by consumers rather than a single exposure.

In another general aspect, a computer-implemented method comprises: accessing measurement data associated with a group of consumers that have been exposed to at least one advertising creative that is part of an advertising campaign, the measurement data indicating exposure levels for one or more campaign elements associated with the advertising campaign and indicating one or more consumer responses; generating a model based on the accessed measurement data, wherein the model relates probabilities of a positive consumer response to exposure levels for the one or more campaign elements; determining, using the model, a change in a probability of a positive consumer response attributable to the one or more campaign elements; and determining an advertising effectiveness metric based on the determined change in the probability of the positive consumer response.

In yet another general aspect, a system comprises: one or more processing devices; one or more storage devices storing instructions that, when executed by the one or more processing devices, causes the one or more processing devices to: access measurement data associated with a group of consumers that have been exposed to at least one advertising creative that is part of an advertising campaign, the measurement data indicating exposure levels for one or more campaign elements associated with the advertising campaign and indicating one or more consumer responses; generate a model based on the accessed measurement data, wherein the model relates probabilities of a positive consumer response to exposure levels for the one or more campaign elements; determine, using the model, a change in a probability of a positive consumer response attributable to the one or more campaign elements; and determine an advertising effectiveness metric based on the determined change in the probability of the positive consumer response.

In yet another aspect, a computer storage medium encoded with a computer program, the program comprising instructions that when executed by one or more computers cause the one or more computers to perform operations comprising: accessing measurement data associated with a group of consumers that have been exposed to at least one advertising creative that is part of an advertising campaign, the measurement data indicating exposure levels for one or more campaign elements associated with the advertising campaign and indicating one or more consumer responses; generating a model based on the accessed measurement data, wherein the model relates probabilities of a positive consumer response to exposure levels for the one or more campaign elements; determining, using the model, a change in a probability of a positive consumer response attributable to the one or more campaign elements; and determining an advertising effectiveness metric based on the determined change in the probability of the positive consumer response.

The advertising effectiveness metric may indicate the contribution of the one or more elements of the campaign to an overall effectiveness of the campaign.

In addition, the one or more campaign elements may comprise a plurality of different campaign elements. For example, the plurality of different campaign elements may comprise different creatives and different publishers.

Determining, using the model, a change in a probability of a positive consumer response attributable to the one or more elements of the campaign may comprise determining a portion of an overall advertising effectiveness of the campaign that is attributable to the one or more campaign elements. Determining, using the model, a change in a probability of a positive consumer response attributable to the one or more campaign elements also may comprise determining a change in a probability of a positive consumer response attributable to exposure to a combination of campaign elements. Determining an advertising effectiveness metric based on the determined change in the probability of the positive consumer response measure also may comprise determining an advertising effectiveness metric indicating an advertising effectiveness attributable to a campaign element or a group of campaign elements. Determining an advertising effectiveness metric based on the determined change in the probability of the positive consumer response measure also may comprise determining an advertising effectiveness metric indicating an advertising effectiveness of a first one of the campaign elements relative to an advertising effectiveness of a second, different one of the campaign elements.

The model may further relate to probabilities of a positive consumer response to consumer attributes where determining, using the model, a change in a probability of a positive consumer response attributable to the one or more campaign elements may comprise determining a change in probability due to the one or more campaign elements and not due to consumer attributes.

The one or more exposure levels may comprise at least one exposure level for each consumer of the group of consumers, and the one or more consumer responses comprise at least one consumer response for each consumers of the group of consumers. The one or more exposure levels also may each indicate individual exposures of a creative in the campaign to a consumer.

The one or more exposure levels may comprise exposure levels indicating exposure to different creatives in the advertising campaign. The one or more exposure levels comprise exposure levels may indicate exposure to different publishers providing creatives in the campaign. The one or more exposure levels comprise exposure levels also may indicate exposure to different combinations of creatives in the advertising campaign and publishers providing the creatives.

Determining an advertising effectiveness metric based on the determined change in the probability of the positive consumer response measure and the accessed measurement data may comprise: accessing panel data that indicates exposures of a panel of users to the advertising campaign; projecting the panel data to a population exposed to the campaign to generate projected exposure data; and determining an advertising effectiveness metric based on the determined change in the probability of the positive consumer response measure and the projected exposure data.

Determining an advertising effectiveness metric based on the determined change in the probability of the positive consumer response measure and the accessed measurement data also may comprise determining the advertising effectiveness metric based on advertising exposures for which no subsequent consumer responses are available.

Generating a model based on the accessed measurement data may comprise generating a model based on the accessed measurement data such that the one or more consumer responses indicated by the measurement data are related to a plurality of exposures that are indicated by the measurement data to have occurred prior to the corresponding consumer responses.

The advertising effectiveness measure may indicate effectiveness with respect to one or more attitudinal or behavioral responses. The attitudinal responses may include one or more of brand favorability, intent to purchase, brand recommendation, unaided awareness, or recall. The behavioral responses may include one or more of website visitation, brand, product, or service searching, or purchase of a product or service.

Implementations of any of the techniques described in this document may include a method or process, an apparatus, a machine, a system, or instructions stored on a computer-readable storage device. The details of particular implementations are set forth in the accompanying drawings and description below. Other features will be apparent from the following description, including the drawings, and the claims.

### BRIEF DESCRIPTION OF THE DRAWINGS

FIG. 1A is a block diagram of an example of a system for providing advertisements to viewers of web pages or other network-accessible resources and to measure consumer responses of at least some of those viewers.

FIG. 1B shows an example block diagram of a web page.

FIG. 1C illustrates an example of a system in which a panel of users may be used to perform Internet audience measurement.

FIG. 2 illustrates an example of a system in which effectiveness measurement data can be used to generate an advertising effectiveness metric.

FIG. 3 is a flow chart illustrating an example of a process for determining an advertising effectiveness metric for one or more advertising campaigns.

FIGS. 4 and 5 are bar graphs illustrating examples of effectiveness metrics.

### DETAILED DESCRIPTION

The following describes techniques for determining the effectiveness of elements of an advertising campaign and combinations of those elements. The level of advertising exposure experienced by consumers can be monitored, and users can provide input about the effects of an advertising campaign in, for example, survey responses. The exposure history and consumer input can be used to generate a model for the effects of the advertising campaign.

The model can indicate the relative effectiveness of different elements of an advertising campaign. The model can indicate, for example, differences between the effects of exposure to a first creative and the effects of exposure to a second creative. The model can also indicate differences between the effects of advertising through one publisher (e.g., a first web page or website) and effects of advertising through another publisher (e.g., a second web page or website). Unlike prior approaches that, for example, attribute all of the branding effect to the publisher or creative associated with a survey research respondent's last exposures to the creative prior to taking the survey, the model can account for all of a respondent's exposures to creatives across all publishers, including those exposures that occur prior to and following a survey experience. As a result, the metrics generated may reflect the composite effects of an entire campaign rather than a survey-only view. Being able to capture a complete view of creative exposures allows for informed attribution to a publisher and advertising creative as well as accurate, holistic campaign measurement.

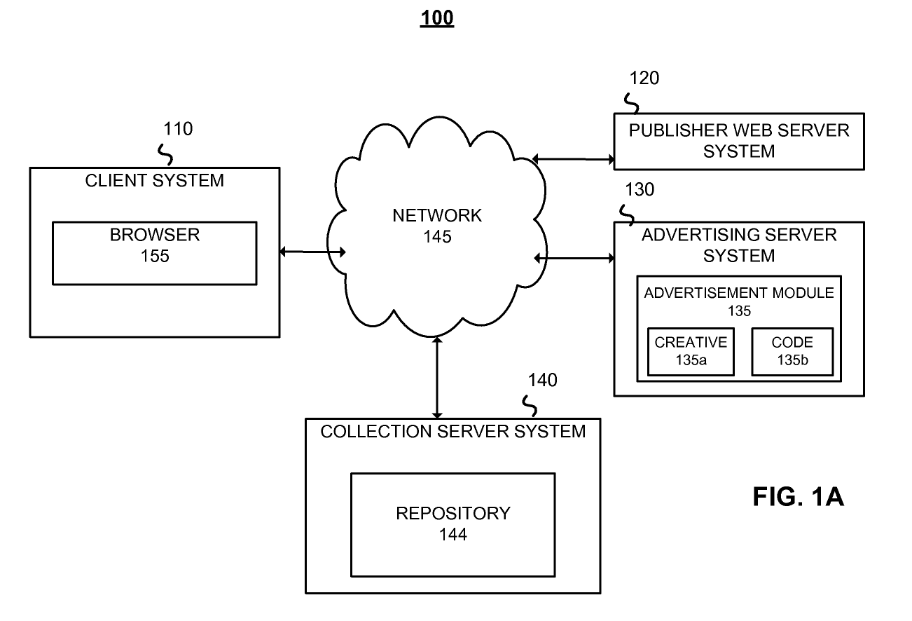

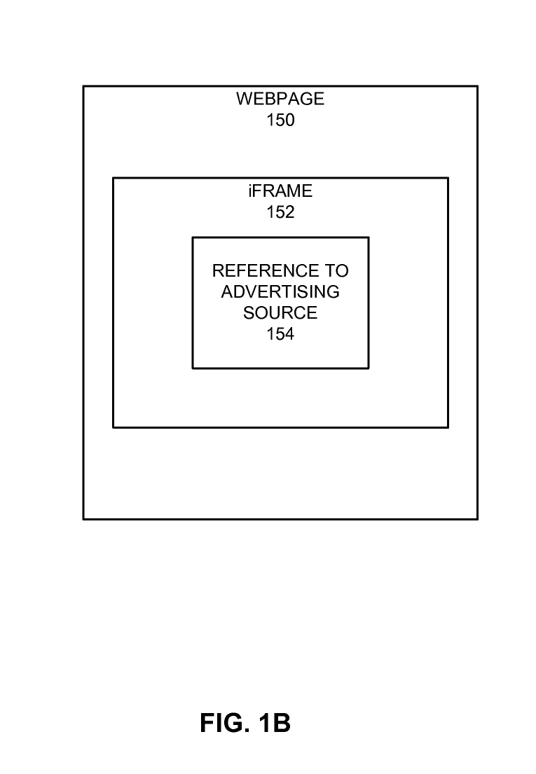

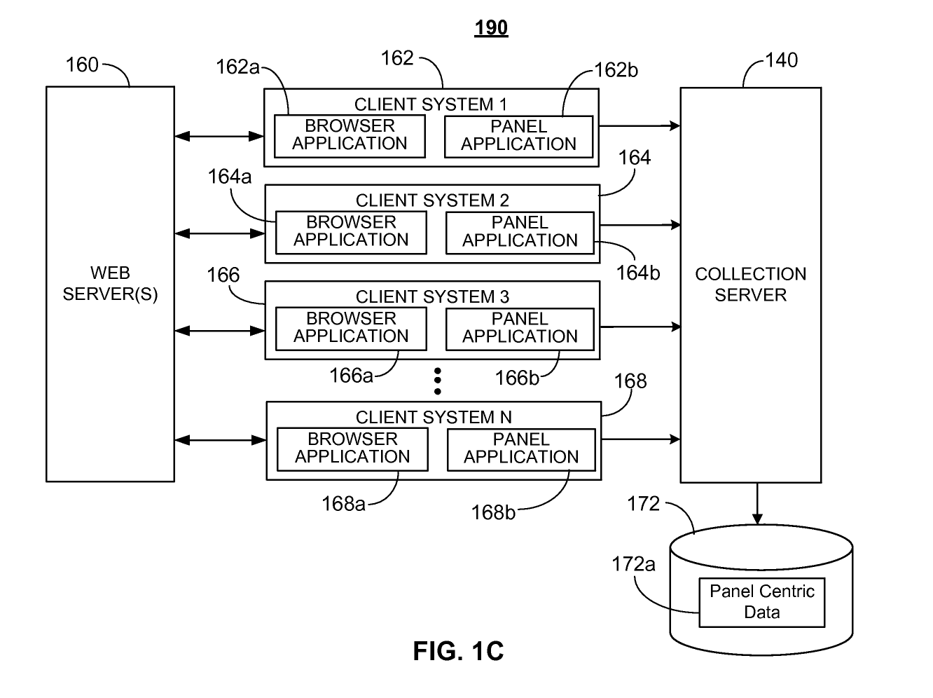

Referring to FIG. 1A, a system 100 includes one or more client systems 110, one or more publisher web server system 120, one or more advertising server systems 130, and one or more collection server systems 140 that communicate and exchange data through a network 145. The system 100 may be used to provide advertisements to viewers of web pages or other network-accessible resources and to measure consumer responses of at least some of those viewers.

Each of the client system 110, the publisher web server system 120, the advertising server system 130, and the collection server system 140 may be implemented using, for example, one or more processing devices capable of responding to and executing instructions in a defined manner, including, for instance, a general-purpose computer, a personal computer, a special-purpose computer, a workstation, a server, or a mobile device. The client system 110, the publisher web server system 120, the advertising server system 130, and the collection server system 140 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by the client system 110, the publisher web server system 120, the advertising server system 130, and the collection server system 140.

In general, the client system 110 includes a web browser 155 that can be used by a user of the client system 110 to retrieve and present web pages or other resources from the network 145, such as the Internet. The publisher web server system 120 may store such web pages or other resources, and transmit those web pages to the client system 110 when requested by the web browser 155.

The advertising server system 130 may store one or more advertisement modules 130 that are retrieved and rendered as part of one or more of the web pages provided by the publisher web server system 120. The advertising module 135 may be, for example, implemented as a Hypertext Markup Language (HTML) file, a shockwave application, or a Java applet.

The advertising module 135 includes an advertising creative 135a. The advertising creative 135a in a given advertisement module 135 is the image, video, sound, graphics, text, animations, or other information that is to be presented when the advertising module 135 is rendered by a web browser and the displayed creative is to be perceived by a person.

While only a single advertisement module is illustrated, the advertising server system may store multiple advertisement modules, and the advertisement modules may be organized according to advertising campaigns. In general, an advertising campaign is a collection of one or more advertisement messages or creatives that share a single idea and/or theme and which typically form an integrated marketing communication (IMC). Thus, the advertisement modules 135 that include creatives 135a belonging to the same advertising campaign may be grouped together as being part of the advertising campaign, and the advertisement modules 135 that include creatives 135a belonging to the same advertising campaign may be associated with a campaign identifier.

The advertising module 135 also includes code 135b. The code 135b is executed by a processing device when the advertising module 135 is rendered by a web browser (typically as part of a web page, as described below). When the code 135b is executed, the code 135b performs functions related to tracking exposures of the creatives in the advertising campaign as well as providing surveys, as described further below.

FIG. 1B is a diagram illustrating an example of a web page 150 that may be provided by the publishing web server system 120. The web page 150 may include an iFrame 152, which may be located in a portion of the web page 150 reserved for presenting an advertisement. The iFrame 152 acts as a container, or placeholder, for content and the iFrame 152 includes a reference (e.g., a uniform resource locator (URL)), or a pointer, to an advertising source 154. The advertising source 154 may be, for example, the advertising server system 130. Through the reference to the advertising source 154, the iFrame 152 obtains content for display within the iFrame 152 from the advertising source. For example, the iFrame 152 may reference the advertising server system 130 such that an advertising module 135 is downloaded to the client computer 110 and rendered within the iFrame 152, which may result in the creative 135a being displayed in the iFrame 152 (and thus in the rendered web page) and the code 135b being executed.

Referring again to FIG. 1A, during operation, the client system 110, through the web browser 155, requests a web page, such as the web page 150, from the publishing web server 120. The publishing web server system 120 sends the web page 150 to the client system 110 and the web page 150 is rendered by the web browser 155. When the iFrame 152 is rendered, the reference 154 results in the web browser 155 sending a request to the advertising server system 130 for an advertisement module 135. The advertising server system 130 selects a particular advertisement module 135 and returns the selected advertisement module 135 to the client system 110 for rendering by the web browser 155 in the iFrame 152. While an example employing an iFrame is described, other implementations may include the advertisement module 135 in the web page without using an iFrame.

When the advertisement module 135 is rendered, the creative 135a is displayed in the iFrame 152. In addition, the code 135b is executed. In general, the code 135b includes exposure code for tracking and reporting the number of times the creative 135a, or another creative in the advertising campaign, has been displayed by the browser 155 (referred to as beacon code). The code 135b also includes survey code for determining whether the user viewing the web page should be solicited to take a survey, as well as providing the survey if the user agrees to take the survey.

In particular, when the beacon code 208 is rendered or executed, the beacon code 208 causes the browser application 204 to send a message to the collection server 130. This message includes certain information. For example, in one implementation, the beacon message may include a campaign project identifier, a creative identifier, an exposure frequency parameter, a client identifier, and an identifier (e.g., URL) of the web page in which the advertisement module 135 is included. The beacon message can also include a timestamp indicating a time and date at which an exposure occurred.

The campaign project identifier identifies the advertising campaign of which the particular creative 135a included with the advertisement module 135 is a part. The campaign project identifier also may identify the associated brand, product, or service associated with the campaign. The creative identifier identifies the specific creative 135a included with the advertisement module 135. As noted earlier, multiple creatives can be associated with the campaign.

The exposure frequency parameter indicates how many times a user of the client system 110 has been exposed to a particular creative in the campaign. The number of times a creative has been displayed on the client system 110, or at least by the particular web browser 155, may act as a surrogate for the actual number of times a given user has been exposed to the creative. This approximation may be useful in scenarios in which it is difficult or impossible to track the actual number of times a particular user is exposed to the creative.

In some implementations, the exposure frequency parameter and other parameters are stored in a cookie on the client system 110. For example, a cookie can store exposure frequency parameters for each creative displayed by the client system 110. The beacon code 135b may access the cookie, update an exposure frequency parameter in the cookie (to account for the current exposure), and include the updated exposure frequency parameter in the beacon message. Exposure frequency parameters may be associated with a particular campaign identifier. As a result, multiple exposure frequency parameters and campaign identifiers may be stored in the cookie to indicate the number of exposures to various creatives in different campaigns. In other implementations, different cookies may be used for different campaigns.

As noted above, the message may also include a unique identifier for the client system 110 (or at least web browser 155). For example, when a client system first sends a beacon message to the collection server 130, a unique identifier may be generated for the client system 110 (and associated with the received beacon message). That unique identifier may then be included in the cookie that is set on that client system 102. As a result, later beacon messages from that client system (or at least from the browser 155) may have the cookie appended to them such that the messages include the unique identifier for the client system 110, or the client identifier may be retrieved from the cookie and included in a parameter of the beacon message. If a beacon message is received from the client system 110 without the cookie (e.g., because the user deleted cookies on the client system 110 or the user of client system 110 is using a browser other than browser 155), then the collection server 140 may again generate a unique identifier and include that identifier in a new cookie set of the client system 110.

The beacon message also may include the URL of the web page in which the advertisement module 135 is included. The beacon code 135b may make a call to the browser 155 for this information, and populate the URL in a parameter of the beacon message.

As an example, the beacon code may be JavaScript code that collects the information to be included in the beacon message as needed and sends the beacon message, including the information, to the collection server 130 as an HTTP Post message that includes the information in a query string. Similarly, the beacon code may be JavaScript code that collects the information as appropriate, and includes that information in the “src” attribute of an <img> tag, which results in a request for the resource located at the URL in the “src” attribute of the <img> tag to the collection server 140. Because the information is included in the “src” attribute, the collection server 140 receives the information. The collection server 140 can then return a transparent image. The following is an example of such JavaScript:

<script type=“text/javascript”>
document.write(“<img id=‘img1’ height=‘1’

width=‘1’>”);document.getElementById(“img1”).src=“http://example.com/scripts/report.dll?P1=
” + escape(window.location.href) + “&rn=” + Math.floor(Math.random( )*99999999);

</script>

The collection server 140 records the information received in the message with, for instance, a time stamp of when the message was received and the IP address of the client system 110 from which the message was received. The collection server 140 aggregates this recorded information and stores this aggregated information in repository 144 as exposure data. The collection server 140 can identify occurrences of the client system 110 (or browser) identifier in the exposure data to determine the history of exposures for a particular client system 110 (or browser). The collection server 140 can thus extract exposure history information for the client device 110 that indicates, for example, which creatives were displayed, the number of times each creative was displayed, and on which web page each display occurred.

Also as noted above, the beacon code 135b also includes survey code that evaluates certain parameters to determine whether to solicit the user viewing the web page to take a survey. For example, the survey code may evaluate a frequency at which surveys should be solicited, as well as whether or not a survey has been solicited on the client system 110 (which may be indicated, for example, in a cookie on client system 110).

If so, the survey code may cause an invitation to be displayed in web browser 155, where the invitation invites the user to take the survey. Assuming the user agrees to take the survey, the survey code displays the survey, for example, by opening another window or tab of browser 155 and causing the browser 155 to retrieve and display the survey. For instance, the survey may be retrieved from the collection server system 140.

In general, the survey includes questions related to a particular, desired consumer response to the creatives in the advertising campaign. For instance, the survey may include questions related to brand favorability (whether a consumer has a positive attitude towards the brand), brand preference (whether a consumer selects a brand or product out of a list including other brands or products), intent to purchase (whether the consumer intends to purchase a particular product or service), intent to visit (whether the consumer intends to visit a web site or physical store within a time period), brand recommendation (whether a consumer would recommend the brand to others), unaided awareness (whether a consumer, without prompting, lists one of the creatives when asked to list all advertisements he or she has seen in a particular category), or recall (whether a consumer lists a particular brand, product, or service when asked to list brands, products, or services in a particular category).

Surveys, such as those for brand favorability, intent to purchase, and brand recommendation may, for example, ask questions related to one or more of these responses, and ask the user to answer by selecting a number on a particular scale. For example, a survey may ask a user to rank, from 1 to 9, how favorably the user thinks about a particular brand. Responses above a certain number may be considered a positive consumer response, while responses below a certain number may be considered negative consumer responses (for example, responses of 8 and 9 may be considered positive responses).

Surveys for, for instance, for unaided awareness and recall may ask a user to list the advertisements, brands, products, or services in a particular category. Responses that include a creative in the campaign (unaided awareness), or a brand, product, or service that is the target of the campaign (recall) may be considered positive consumer responses, while those that don't are considered negative consumer responses.

Once the user answers the questions on the survey, the results are sent to the collection server 140, together, for example, with the campaign project identifier, the client identifier, and the exposure frequency parameter. The URL or other identifier for the web page from which the survey was served can also be included with the results. The collection server 140 records this information with, for instance, a time stamp of when the message was received and the IP address of the client system 110 from which the message was received. The collection server 140 aggregates this recorded information and stores this aggregated information in repository 144 as response data.

While the implementation described above initiates the survey using the beacon code that is part of the advertisement module that includes the creative shown, other implementations may initiate a survey from other advertisement modules or from the publisher or other web pages, or the surveys may be administered through other channels.

As described in more detail below, the exposure data and the response data may be used to determine one or more effectiveness metrics regarding the effectiveness of the advertising campaign at achieving the desired consumer response. For instance, this data may be used to model the relative effectiveness of different creatives, different types of creatives, different web pages/websites, or different combinations of creatives and web pages/websites.

Furthermore, the effectiveness measurement data 202, including the exposure data 202a and the response data 202b, may be collected in manners other than those described above with respect to FIG. 1. For example, a panel of users may have monitoring applications installed on client systems of the users, and the monitoring applications are able to collect and report when a particular user or client system is exposed to a creative in the campaign, as well as actions taken by the users, such as visiting certain websites, searching for certain terms, or purchasing certain products from a web site. Thus, the panel may be used to obtain data regarding exposures to creatives that are part of the campaign as well as consumer responses. As another example, some of all of the data may be provided by a third party that collects such data. For instance, a third party may collect offline shopping data, which may be used to determine purchases.

FIG. 1C illustrates an example of a system 190 in which a panel of users may be used to collect data for Internet audience measurement. The system 100 includes client systems 112, 164, 166, and 168, one or more web servers 160, the collection server 140, and a database 172. In general, the users in the panel employ client systems 162, 164, 166, and 168 to access resources on the Internet, such as webpages located at the web servers 160. Information about this resource access is sent by each client system 162, 164, 166, and 168 to a collection server 140. This information may be used to understand the usage habits of the users of the Internet.

Each of the client systems 162, 164, 166, and 168, the collection server 140, and the web servers 160 may be implemented using, for example, a processing device, such as a general-purpose computer capable of responding to and executing instructions in a defined manner, a personal computer, a special-purpose computer, a workstation, a server, a microprocessor, or a mobile device. Client systems 162, 164, 166, and 168, collection server 140, and web servers 160 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by a client system 162, 164, 166, and 168, collection server 140, and web servers 160.

In the example shown in FIG. 1C, the system 190 includes client systems 162, 164, 666, and 168. However, in other implementations, there may be more or fewer client systems. Similarly, in the example shown in FIG. 1C, there is a single collection server 140. However, in other implementations there may be more than one collection server 140. For example, each of the client systems 162, 164, 166, and 168 may send data to more than one collection server for redundancy. In other implementations, the client systems 162, 164, 166, and 168 may send data to different collection servers, for example, based volume of users, resources, load handling/balancing, and/or for other reasons, such as geography or network topology. In this implementation, the data, which represents data from the entire panel, may be communicated to and aggregated at a central location for later processing. The central location may be one of the collection servers.

The users of the client systems 162, 164, 166, and 168 are a group of users that are a representative sample of the larger universe being measured, such as the universe of all Internet users or all Internet users in a geographic region. To understand the overall behavior of the universe being measured, the behavior from this sample is projected to the universe being measured. The size of the universe being measured and/or the demographic composition of that universe may be obtained, for example, using independent measurements or studies. For example, enumeration studies may be conducted monthly (or at other intervals) using random digit dialing.

Similarly, the client systems 162, 164, 166, and 168 are a group of client systems that are a representative sample of the larger universe of client systems being used to access resources on the Internet. As a result, the behavior on a machine basis, rather than person basis, can also be, additionally or alternatively, projected to the universe of all client systems accessing resources on the Internet. The total universe of such client systems may also be determined, for example, using independent measurements or studies

The users in the panel may be recruited by an entity controlling the collection server 140, and the entity may collect various demographic information regarding the users in the panel, such as age, sex, household size, household composition, geographic region, number of client systems, and household income. The techniques used to recruit users may be chosen or developed to help insure that a good random sample of the universe being measured is obtained, biases in the sample are minimized, and the highest manageable cooperation rates are achieved. Once a user is recruited, a monitoring application is installed on the user's client system. The monitoring application collects the information about the user's use of the client system to access resources on the Internet and sends that information to the collection server 140.

For example, the monitoring application may have access to the network stack of the client system on which the monitoring application is installed. The monitoring application may monitor network traffic to analyze and collect information regarding requests for resources sent from the client system and subsequent responses. For instance, the monitoring application may analyze and collect information regarding HTTP requests and subsequent HTTP responses.

Thus, in system 100, a monitoring application 162b, 164b, 166b, and 168b, also referred to as a panel application, is installed on each of the client systems 162, 164, 166, and 168. Accordingly, when a user of one of the client systems 162, 164, 166, or 168 employs, for example, a browser application 162a, 164a, 166a, or 168a to visit and view web pages, information about these visits may be collected and sent to the collection server 140 by the monitoring application 162b, 164b, 166b, and 168b. For instance, the monitoring application may collect and send to the collection server 140 the URLs of web pages or other resources accessed, the times those pages or resources were accessed, and an identifier associated with the particular client system on which the monitoring application is installed (which may be associated with the demographic information collected regarding the user or users of that client system). For example, a unique identifier may be generated and associated with the particular copy of the monitoring application installed on the client system. The monitoring application also may collect and send information about the requests for resources and subsequent responses. For example, the monitoring application may collect the cookies sent in requests and/or received in the responses. The collection server 140 receives and records this information. The collection server 140 aggregates the recorded information from the client systems and stores this aggregated information in the database 172 as panel centric data 172a.

The panel centric data 172a may be analyzed to determine the visitation or other habits of users in the panel, which may be extrapolated to the larger population of all Internet users. The information collected during a particular usage period (session) can be associated with a particular user of the client system (and/or his or her demographics) that is believed or known to be using the client system during that time period. For example, the monitoring application may require the user to identify his or herself, or techniques such as those described in U.S. Patent Application No. 2004-0019518 or U.S. Pat. No. 7,260,837, both incorporated herein by reference, may be used. Identifying the individual using the client system may allow the usage information to be determined and extrapolated on a per person basis, rather than a per machine basis. In other words, doing so allows the measurements taken to be attributable to individuals across machines within households, rather than to the machines themselves.

As described further below, the panel centric data 172a can be used below to generate a model that indicates the effectiveness of different elements of an advertising campaign. As described above, panel centric data 172a can indicate the history of exposures to creatives experienced by members of the panel and the behavior of members of the panel (e.g., web page/website usage, clicks on advertisements, and searches performed) correlated to those exposure histories. Thus the panel centric data 172a can be used in place of exposure history and survey response data collected as described with respect to FIG. 1A. As an alternative, panel centric data 172a can be used to supplement the survey response data collected from users who are not members of the panel. For example, the survey response data may be used to generate some parameters of an advertising effectiveness model, and panel centric data 172a can be used to calibrate the generated model for a population of users with demographic characteristics different from those of the surveyed users.

To extrapolate the usage of the panel members to the larger universe being measured, some or all of the members of the panel are weighted and projected to the larger universe. In some implementations, a subset of all of the members of the panel may be weighted and projected. For instance, analysis of the received data may indicate that the data collected from some members of the panel may be unreliable. Those members may be excluded from reporting and, hence, from being weighted and projected.

The reporting sample of users (those included in the weighting and projection) are weighted to insure that the reporting sample reflects the demographic composition of the universe of users to be measured, and this weighted sample is projected to the universe of all users. This may be accomplished by determining a projection weight for each member of the reporting sample and applying that projection weight to the usage of that member. Similarly, a reporting sample of client systems may be projected to the universe of all client systems by applying client system projection weights to the usage of the client systems. The client system projection weights are generally different from the user projection weights.

The usage behavior of the weighted and projected sample (either user or client system) may then be considered a representative portrayal of the behavior of the defined universe (either user or client system, respectively). Behavioral patterns observed in the weighted, projected sample may be assumed to reflect behavioral patterns in the universe.

Estimates of visitation or other behavior can be generated from this information. For example, this data may be used to estimate the number of unique visitors (or client systems) visiting certain web pages or groups of web pages, or unique visitors within a particular demographic visiting certain web pages or groups of web pages. This data may also be used to determine other estimates, such as the frequency of usage per user (or client system), average number of pages viewed per user (or client system), and average number of minutes spent per user (or client system).

Such estimates and/or other information determined from the panel centric data may be used with data from a beacon-based approach, as described above, to generate reports about audience visitation or other activity. Using the panel centric data 172a with data from a beacon-based approach may improve the overall accuracy of such reports. Nevertheless, a beacon-based approach is not required to collect the panel centric data 172a.

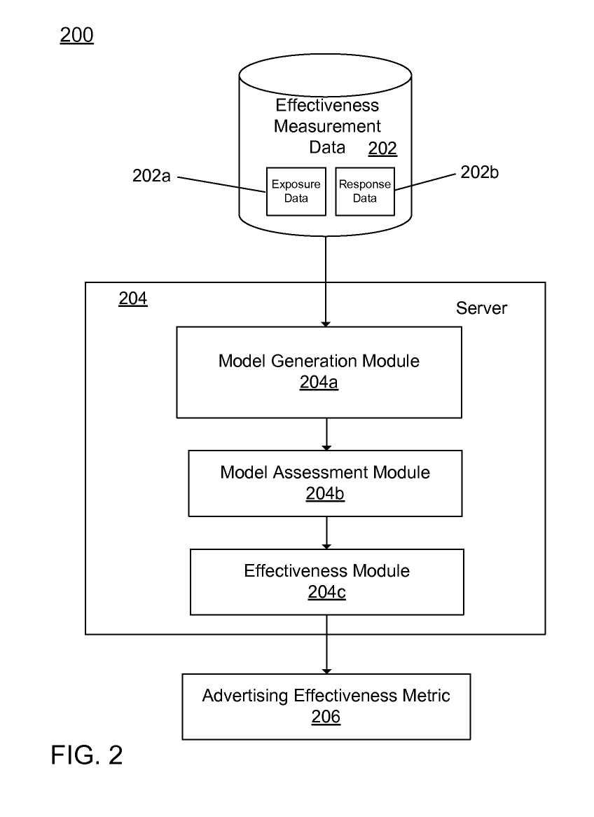

FIG. 2 illustrates an example of a system 200 in which effectiveness measurement data 202 can be used to generate an advertising effectiveness metric 206. The system 200 includes an effectiveness measurement server 204. The effectiveness measurement server 202 may be implemented using, for example, one or more processing devices capable of responding to and executing instructions in a defined manner, including, for instance, a general-purpose computer, a personal computer, a special-purpose computer, a workstation, a server, a microprocessor, or a mobile device. The effectiveness measurement server 202 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by the effectiveness measurement server 202.

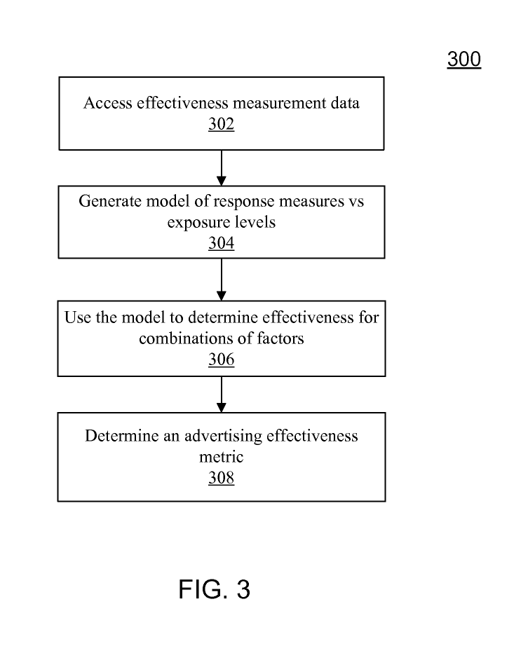

The effectiveness measurement server 202 includes one or more processing devices that execute instructions that implement a model generation module 204a, a model assessment module 204b, and an effectiveness module 204c. The various modules implemented by effectiveness measurement server 204 may perform a process, such as that shown in FIG. 3, to generate an advertising effectiveness metric 206 for one or more advertising campaigns.

FIG. 3 is a flow chart illustrating an example of a process 300 for determining an advertising effectiveness metric for one or more advertising campaigns. The following describes process 300 as being performed by the model generation module 204a, the model assessment module 204b, and the effectiveness module 204c. However, the process 400 may be performed by other systems or system configurations.

The model generation module 204a accesses the effectiveness measurement data 202 for a group of users that have been exposed to at least one advertising creative that is part of an advertising campaign (302). The effectiveness measurement data 202 may include the exposure data 202a and the response data 202b described above with respect to FIG. 1. In one implementation, the effectiveness measurement data reflects attitudinal-based consumer responses (e.g., brand favorability, intent to purchase, brand recommendation, unaided awareness, or recall), with positive consumer responses being those described above, for instance.

In some implementations, the effectiveness measurement data may reflect behavior-based consumer responses in addition to or as an alternative to survey-based responses. For example, the effectiveness data may reflect whether or not users within the group of users exposed to a creative in the campaign visited a particular website corresponding to the brand, product, or service associated with the advertising campaign. In this case, a positive consumer response may be a visit to the website. As another example, the effectiveness data may reflect whether or not the users within the group of users exposed to a creative in the campaign performed a search (e.g., used a web search engine such as Google®) for the brand, product, or service associated with the advertising campaign. In this case, a positive consumer response may be the user conducting such a search. As an additional example, the effectiveness data may reflect whether or not the users within the group of users exposed to a creative in the campaign purchased a corresponding product or service, with a purchase being a positive consumer response.

In any event, the measurement data 202 reflects one or more consumer responses and one or more non-zero exposure levels. Each exposure to a creative in the advertising campaign can be detected and stored in the measurement data. For example, the measurement data 202 may reflect, for each user in a set of users, exposure data 202a that indicates each user's history of exposure to different creatives and publishers and corresponding response data 202b including survey responses. The measurement data 202 can also include the panel centric data 172a for a different set of users, such as members of a panel, that may not have submitted survey responses.

Based on the accessed effectiveness measurement data 202, the model generation module 204a generates a model that relates consumer response measures to one or more exposure levels (304). For example, the consumer response measures may be the probabilities that a user exhibits a positive consumer response at a given exposure level.

In particular, the generated model can indicate the relative contributions of different elements of the advertising campaign. For example, the model can indicate the probability that a user exhibits a positive response based on exposure to a particular creative, exposure through a particular publisher, or exposure to a particular creative through a particular publisher. Because the model is generated using the exposure data 202a, the effects indicated in a user's survey response can be attributed to each of multiple different exposures experienced by the user. As a result, the entire effectiveness indicated in a survey response need not be attributed to a single exposure, such as the exposure occurring most recently before the survey response was submitted. In some implementations, the model is a causal model that relates the probability of achieving a positive consumer response as a function of consumer attributes and campaign exposures delivered by each publisher and each creative.

In further detail, the model, which can be a Probit regression model, can include regression coefficients corresponding to exposure to different creatives and exposure through different publishers (e.g., different web pages). An outcome measure, y, can be expressed in a binary manner so that, for example, a value of one represents a positive survey response and a value of zero represents a negative or neutral survey response. The model can indicate a probability, P(y=1), that the outcome measure is positive for one or more users. In the aggregate, the probability, P(y=1) can also indicate a proportion of people in a population who would be expected to respond positively for the outcome measure, y.

The model can indicate probabilities for various combinations of elements in a marketing campaign. For example, the model can indicate, for a given demographic profile and level of advertising exposure, a probability that the outcome measure, y, is positive. A matrix, X, can indicate a particular set of demographic attributes, level of exposure to different creatives, and level of advertising exposure through different publishers. Given the matrix, X, a model indicating probability with respect to demographics, creatives, and publishers can be generated using the following equation:

$$P ( y = 1 \vert Demos , Creatives , Publisters ) = Φ ( \begin{matrix}\begin{matrix}\begin{matrix}{α}_{0} + {α}_{{demo}_{1}} {X}_{{demo}_{1}} + … + {α}_{{demo}_{i}} {X}_{{demo}_{i}} + \\ {β}_{{creative}_{1}} {X}_{{creative}_{1}} + … + {β}_{{creative}_{j}} {X}_{{creative}_{j}} +\end{matrix} \\ {π}_{{publisher}_{1}} {X}_{{publisher}_{1}} + … + {π}_{{publisher}_{k}} {X}_{{publisher}_{k}} +\end{matrix} \\ ε\end{matrix} )$$

where:

Φ signifies a cumulative distribution function of the standard normal distribution,

X is the matrix specifying a combination of demographic attributes, exposures to different creatives, and exposures through different publishers,

α₀ is a constant term, referred to as an “intercept,”

α_{demo1}, . . . , α_{demoi} are coefficients for i different demographic attributes,

β_{creative1}, . . . , β_{creativej} are coefficients for j different creatives,

π_{publisher1}, . . . , π_{publisherk} are coefficients for k different publishers, and

ε represents random error.
The coefficients β_{creative1}, . . . , β_{creativej} and π_{publisher1}, . . . , π_{publisherj} are constrained to be greater than or equal to zero.

The terms of the matrix, X, can represent particular combinations of attributes or experiences for which the probability is desired. For example, X_{demo1} can indicate whether a user is male or female, X_{demo2} can indicate a user's age, and so on. X_{creative1} can indicate a number of exposures to a first creative, X_{creative2} can indicate a number of exposures to a second creative, and so on. X_{publisher1} can indicate a number of exposures to any creative in the advertising campaign through a first publisher, X_{publisher2} can indicate a number of exposures to any creative in the advertising campaign through a second publisher, and so on.

The values of the factors in the model may be numbers representing categories or buckets of the factors. For example, age may receive a value of 1 if the age is between 18-54 years and a 2 if the age is 55 or older; gender may receive a value of 1 if male and 2 if female; usage of a product may receive a value of 1 if used in the past month, 2 if used over a month ago, and 3 if never used; income may receive a value of 1 if the income is less than 60K and a 2 if greater than 60K, and exposures may receive the number corresponding to the number of exposures. This is represented, for example, by the following table (Table 1):

TABLE 1

| AGE | GENDER | USAGE | Income |
|---|---|---|---|
| 1: 18-54 | 1: Male | 1: Used in the past month | 1: Less than 60K |
| 2: 55+ | 2: Female | 2: Over a month ago to over | 2: More than 60K |
| | | 12 months ago | |
| | | 3: Never | |

In other implementations, the factors may be continuous values across their ranges (for example, age could be any value between 0 and 150).

The coefficients, α_{demo1}, . . . , α_{demoi}, β_{creative1}, . . . , β_{creativej}, π_{publisher1}, . . . , π_{publisherj}, and the constant α₀ can be determined using optimization and regression techniques. The error term, ε, need not be fitted in the optimization process. The model parameters are estimated based on a data set from the effectiveness measurement data 202. For example, the parameters can be selected such that the probabilities for the output measure, y, indicated by the response data 202b are generated given the exposure histories indicated by the exposure data 202a. The individual exposure histories and survey responses for individuals can be used as data points to guide the calculation of the coefficients. Thus the model reflects probabilities corresponding to the varied levels of exposure to different creatives and publishers and varied demographic attributes reflected by the effectiveness measurement data 202. Because the model accounts for varying levels of exposure to different combinations of publishers and creatives, the model can be generated to distribute the effectiveness indicated by a survey response across each exposure of an individual prior to the survey response, not simply the single exposure occurring most recently before a survey response.

An example of an algorithm that can be used to calculate parameters for the model is a limited-memory Broyden-Fletcher-Goldfarb-Shanno (BFGS) algorithm that permits an upper and lower bound to be set for each variable (known as a L-BFGS-B algorithm). Such an algorithm is described in described in “A limited memory algorithm for bound constrained optimization” by Richard H. Byrd, Peihuang Lu, Jorge Nocedal, Ciyou Zhu, SIAM Journal on Scientific Computing, v.16 n.5, p.1190-1208, Sept. 1995, which is incorporated herein by reference in its entirety.

In some implementations, the data used to generate parameters for the model is collected from a first set of users, for example, a set of users that submitted survey responses. The model can also be calibrated based on data about a second set of users, for example, the set of users in a panel (such as the one described above), by adjusting the constant, α₀. The constant, α₀, can be adjusted to correct for differences between the populations of the first set of users and the second set of users, through manual adjustment, optimization, or an iterative process of adjustment and optimization. For example, the members of the panel may be a more representative population than users responding to surveys. The panel centric data 172a can be used to calibrate the generated model, for example, to account for differences in the demographic makeup of the two sets of users. To adapt the model for the second set of users, a constant, α₀, determined for the second set of users can be used with the coefficients, α_{demo1}, . . . , α_{demoi}, β_{creative1}, . . . , β_{creativej}, π_{publisher1}, . . . , π_{publisherj}, as determined using data about the first set of users.

Because the expected value of P(y=1|X) when using the estimated coefficients and the data averages is equal to the proportion of survey respondents who respond with a “1” or positive response, α₀ is chosen to satisfy this condition. This is done by minimizing the following equation with respect to α₀:

$${min}_{{α}_{0}} ( \overline{y} - Φ ( {α}_{0} + X β ) )$$

where X is a matrix of panel centric data 172a averages, β is the vector of estimated coefficients and y̅ is the proportion of survey respondents who responded with a “1” or positive survey response. The values included in the matrix, X, (which can have the same form as described above) can be determined by averaging the projected values for the entire population. For example, for a value of the matrix, X, corresponding to income, a value representing the average projected income level from members of the panel can be used.

To verify the statistical significance of the calculated parameters, a test of significance can be performed. As an example, the full model (determined based on demographic attributes, creatives, and publishers) can be compared to a reduced model. The reduced model can be based on demographic attributes and can exclude information about creatives and publishers. The reduced model can be generated as follows:

P(y=1|Demos)=Φ(α₀+α_{demo}_{₁}X_{demo}_{₁}+. . .+α_{demo}_{ᵢ}X_{demo}_{ᵢ})

A test statistic, D, can be calculated using the following equation:

$$D = - 2 ln ( \frac{likihood full model}{likelihood reduced model} )$$

where D is approximately distributed chi-squared with a number of degrees of freedom equaling the number of publishers and creatives for the model. The test statistic, D, can be compared to D′=Chi-square(level, df), where level is the level of significance desired and df are the degrees of freedom equaling the number of publishers and creatives for the model. Coefficients for models that satisfy D>D′ are considered statistically significant.

Using the model, the effect of the combinations of factors are determined (306). For example, a separate measure can be calculated for the effect of each combination of creative and publisher. To determine the effect of a particular combination, the effect on each individual exposed to the combination can be determined. For example, for a set of users that were each exposed to a particular creative through a particular web site, the effect of that exposure can be calculated for each individual using the model.

Effects of advertising exposure can be indicated as “lift,” or the percent change in the probability of a positive consumer response due to an exposure. Lift can be defined as the estimated difference in P(y=1) between the full model and the reduced model, in which information about particular creatives and publishers is not taken into account, for example:

lift=P(y=1|Demos,Creatives,Publishers)−P(y=1|Demos)
The probability P(y=1|Demos) can be calculated with the exposure levels in the matrix, X, set to zero, and thus can represent a zero-exposure level or baseline for a set of demographic attributes. By subtracting the zero-exposure level from the output of the full model, the increase in probability due to exposures in the campaign can be calculated while holding constant other factors, such as demographic attributes.

Lift can be calculated for individual elements of a campaign, such as individual creatives or publishers, or for combinations of elements. Thus lift can be calculated to indicate, for example, the expected incremental increase in probability due to each subsequent exposure to a creative through a particular publisher.

As an example, an advertising campaign may include three different publishers, P₁, P₂, P₃, and two different creatives, C₁, C₂. The measurement data 202 may indicate that, prior to responding to a survey, three different consumers experienced exposures as indicated below in Table 2.

TABLE 2

| Individual 1 | | | Individual 2 | | | Individual 3 | | |
|---|---|---|---|---|---|---|---|---|
| Expo- | | | Expo- | | | Expo- | | |
| sure | Pub. | Cre. | sure | Pub. | Cre. | sure | Pub. | Cre. |
| 1 | P₁ | C₁ | 1 | P₃ | C₂ | 1 | P₁ | C₁ |
| 2 | P₁ | C₁ | 2 | P₃ | C₂ | 2 | P₃ | C₁ |
| 3 | P₂ | C₂ | 3 | P₂ | C₁ | 3 | P₃ | C₁ |
| 4 | P₃ | C₁ | 4 | P₂ | C₁ | 4 | P₁ | C₁ |
| 5 | P₃ | C₂ | | | | 5 | P₁ | C₁ |
| 6 | P₁ | C₂ | | | | 6 | P₃ | C₁ |
| 7 | P₂ | C₂ | | | | 7 | P₁ | C₂ |
| 8 | P₂ | C₂ | | | | | | |
| 9 | P₁ | C₁ | | | | | | |
| 10 | P₁ | C₁ | | | | | | |

From the exposures indicated in the measurement data 202, the total number of times that individuals were exposed to each combination of publisher and creative is indicated in Table 3, below.

TABLE 3

| Individual | P₁C₁ | P₁C₂ | P₂C₁ | P₂C₂ | P₃C₁ | P₃C₂ |
|---|---|---|---|---|---|---|
| 1 | 4 | 1 | — | 3 | 1 | 1 |
| 2 | — | — | 2 | — | — | 2 |
| 3 | 3 | 1 | — | — | 3 | — |

The lift for each combination of publisher and creative experienced by each individual can be determined. That is, for each cell of Table 3, a corresponding lift value can be determined. For example, using the generated model, the lift is calculated by subtracting the probability of a positive outcome based on an individual's demographic attributes alone from the probability of a positive outcome based on the both the particular individual's demographic attributes and the particular individual's experience with a single combination of publisher and creative.

For the exposure of individual 1 to the combination P₁C₁, a first probability P(y=1|Demos, Creatives, Publishers) is calculated by populating the matrix, X, using the demographic attributes of individual 1 and information about the four exposures to the first creative, C₁, through the first publisher, P₁. Information about other exposures to the individual 1 is omitted from the matrix, X. A second probability P(y=1|Demos) is also calculated using the demographic attributes of the individual 1. The lift for the combination P₁C₁ for individual 1 is then calculated by subtracting the second probability from the first probability.

The lift calculations for individual users can then be averaged to determine the average lift for each combination of publisher and creative. For example, the respective lifts calculated for individual 1 and individual 3 for the combination P₁C₁ can be averaged to determine an average lift, P̅₁̅C̅₁̅, for the combination of exposure to the first creative through the first publisher.

The effectiveness module 204c determines an advertising effectiveness metric 206 for the campaign based on the average lift calculations and the accessed measurement data 202 (308). For example, the metric may be a total or relative contribution attributable to a factor or a combination of factors of the campaign. The contributions can be determined using the average lift calculations for the various combinations of factors and the measurement data 202 indicating the number of exposures for each combination.

As an example, an advertising campaign can include three different publishers, P₁, P₂, P₃, and two different creatives, C₁, C₂, and a total of 1000 exposures, reflected in Table 4 below:

TABLE 4

| | C₁ | C₂ |
|---|---|---|
| P₁ | 100 | 200 |
| P₂ | 250 | 150 |
| P₃ | 150 | 150 |

The data used to calculate the effectiveness of the campaign (e.g., the data reflected in Table 4) can be the panel centric data 172a, which may include a larger sample size than data about survey respondents. In addition, the panel may represent a sampling of individuals that may be more representative of the campaign as a whole than survey respondents. Effectiveness metrics based on panel centric data 172a can then be extrapolated to indicate the full effect of the campaign, based on known characteristics of the panel relative to the general population exposed to the advertising campaign.

The contributions of individual elements of an advertising campaign may be calculated using the average lift measurements (e.g., P̅₁̅C̅₁̅, P̅₁̅C̅₂̅, P̅₂̅C̅₁̅, etc.) calculated using the survey data. The total number of exposures in the campaign to the entire population and number of times each creative was displayed through each publisher (e.g., Table 4) to the entire population can be based on the panel centric data 172a. For example, the panel centric data 172a may be used to determine the number of exposures for each member of the panel and number of times each creative was displayed through each publisher to each member of the panel, and each members' projection weights may be applied to the respective counts to provide the total number of each for the entire population. Alternatively, the numbers of exposures used to calculate effectiveness metrics can be based on the beacon data from surveyed individuals, or extrapolated from such data.

To calculate a contribution, the average lift statistic for a combination is multiplied by the number of that combination's occurrence in the campaign, divided by the total number of exposures the campaign. For a single element, rather than a combination of elements, the contribution for each combination with which the element is associated is added together. For example, the contribution for the first publisher, P₁, can be calculated as

$$Contribution ( {P}_{1} ) = \frac{\overline{{P}_{1} {C}_{1}} \times 100}{1000} + \frac{\overline{{P}_{1} {C}_{2}} \times 200}{1000}$$

and the contribution of the first creative, C₁, can be calculated as

$$Contribution ( {C}_{1} ) = \frac{\overline{{P}_{1} {C}_{1}} \times 100}{1000} + \frac{\overline{{P}_{2} {C}_{1}} \times 250}{1000} + \frac{\overline{{P}_{3} {C}_{1}} \times 150}{1000}$$

The contributions indicate the cumulative effect of all exposures involving a particular factor. The value of Contribution (C₁), for example, represents the overall contribution of all exposures to the first creative, C₁, to the effects of the advertising campaign. In a similar manner, the overall effectiveness for the entire campaign can be calculated, for example, by adding together the contributions for each combination of exposures that occurred in the campaign.

To better estimate the performance of each publisher or creative, relative contributions can be calculated that takes into account differences in the number of exposures of different creatives and publishers. The relative contribution can normalize the overall contribution values by the number of exposures that involved a particular element of the campaign. Thus a relative contribution can represent an estimated contribution of a single exposure with a particular publisher or creative, permitting the contributions of different elements of a campaign to be compared directly.

In the current example, because the first publisher, P₁, was involved in a total of three hundred exposures, the relative contribution of the first publisher, P₁, can be calculated as

$$Rel . Contribution ( {P}_{1} ) = \frac{Contribution ( {P}_{1} )}{300}$$

Similarly, the first creative, C₁, was displayed a total of five hundred times, and so the relative contribution can be calculated as

$$Rel . Contribution ( {C}_{1} ) = \frac{Contribution ( {C}_{1} )}{500}$$

Effects attributable to combinations of factors can also be calculated in a similar manner. For example, the contribution due to the combination of the first publisher, P₁, and the first creative, C₁, which occurs one hundred times may be calculated as follows:

$$Contribution ( {P}_{1} {C}_{1} ) = \frac{\overline{{P}_{1} {C}_{1}} \times 100}{1000}$$

$$Rel . Contribution ( {P}_{1} {C}_{1} ) = \frac{Contribution ( {P}_{1} {C}_{1} )}{100}$$

The effectiveness module 204c can determine other advertising effectiveness metrics 206, for example, the overall effectiveness or relative effectiveness of particular types of creatives or publishers. For example, the relative effectiveness of sports web sites versus new web sites can be determined, or the relative effectiveness of banner advertisements and interactive advertisements.

For example, if the first publisher, P₁, and the second publisher, P₂, represent a first type of publisher “Type A”, the contribution for that type of publisher can be calculated as

Contribution(Type A)=Contribution(P₁)+Contribution(P₂)
The relative contribution can be calculated as

$$Rel . Contribution ( Type A ) = \frac{Contribution ( Type A )}{350}$$

As described above, the data set used by the effectiveness module 204c to determine advertising effectiveness metrics 206 may be different from the data set used by the model generation model 204a to generate the model. For example, a data set including data for users that responded to a survey may be used to determine coefficient values for the model and to determine the average lift values for various combinations of publishers and creatives. A second data set representing a larger number of users, for example, panel centric data 172a, may be used to generate the contribution and relative contribution effectiveness measures. For example, because monitoring applications may be able to collect and report when a particular user or client system is exposed to a creative in the campaign, panel centric data 172a may be used to estimate the exposure levels actually experienced during the campaign. The panel centric 172a can be used directly to calculate effectiveness metrics, or can be extrapolated to the entire population exposed to the advertising campaign and then used to calculate effectiveness metrics.

In calculating the overall effect of the advertising campaign, the contribution of each exposure to the effectiveness of the campaign can be calculated, including contributions of exposures to an individual occurring after a survey response from the individual. In some cases, only the exposures to individuals experienced before their respective survey responses are used to generate the coefficients for the model. Once the model is generated, however, the effect of exposures subsequent to a survey response can be estimated using the model and incorporated to the effectiveness of the campaign. As a result, using the generated model, the contribution measurements can be calculated using all exposures indicated in the measurement data 202, including exposures for which no subsequent survey response is received.

The techniques described above can be used to determine the effectiveness of a variety of elements of an advertising campaign, including, for example, publisher, publisher type, advertising creative, creative type, creative placements, and other campaign parameters. In addition, advertising effectiveness measures and campaign contributions can be reported with respect to different audience segments, for example, by demographic groups, interest segments, audience segments from third-party data providers and client-defined segments. In some implementations, the model can be used to determine effectiveness measures for a combination of one or more campaign elements and demographic attributes or audience segments.

Models can be generated for different outcome measures, permitting multiple aspects of the effectiveness of an advertising campaign to be analyzed. In addition, effectiveness models can be generated to represent factors in addition to, or instead of, demographic attributes, creatives, and publishers. As an example, models and effectiveness metrics can be generated to indicate differences in effectiveness of different publisher types. An example of a publisher type is a type of web page/website, for example, a portal site, a specialty retail site, a general retail site, a search site, a sports site, a news site, etc.

The model takes into account a user's personalized exposure history, which indicates the combination of both where an individual was exposed to a particular ad, and which ad they were exposed to. Further, the personalized exposure history indicates the time at which the ad was seen, which permits the timing of exposures to the ads to be taken into consideration in the modeling.

Using the model described above, each exposure to a creative can be modeled to have equal effectiveness. For example, the first exposure of a creative to a user can be assumed to cause the same incremental effect as a second, third, or subsequent exposure to the creative. In some implementations, however, the model generation module 204a can generate a model that reflects varying effectiveness of subsequent exposures to a creative. For example, the model can be generated with additional terms to represent incremental effects of a second exposure, a third exposure, and so on. Different coefficients can represent the incremental effects of multiple exposures to the same creative and/or other creatives in the advertising campaign.

Differences between the effects of first and subsequent exposures can additionally or alternatively be accounted for by altering the inputs to the model. Each exposure in a series of exposures may have a different weighting value, for example, 1.0 for the first exposure, 0.8 for the second exposure, 0.6 for the third exposure, and so on. For example, when three exposures have occurred, an input of 2.4 may be used rather than 3.0. Thus the input weighting values can be used to account for differences in effectiveness between exposures in a sequence of exposures. As another example, weighting values can reflect that exposures occurring recently before a consumer survey response may influence the survey response more than exposures occurring earlier. Input weighting values can be optimized based on a data set or may be manually adjusted. For example, the weighting values can be determined using a geometric decay factor, the value of which is optimized when the coefficients of the model are optimized.

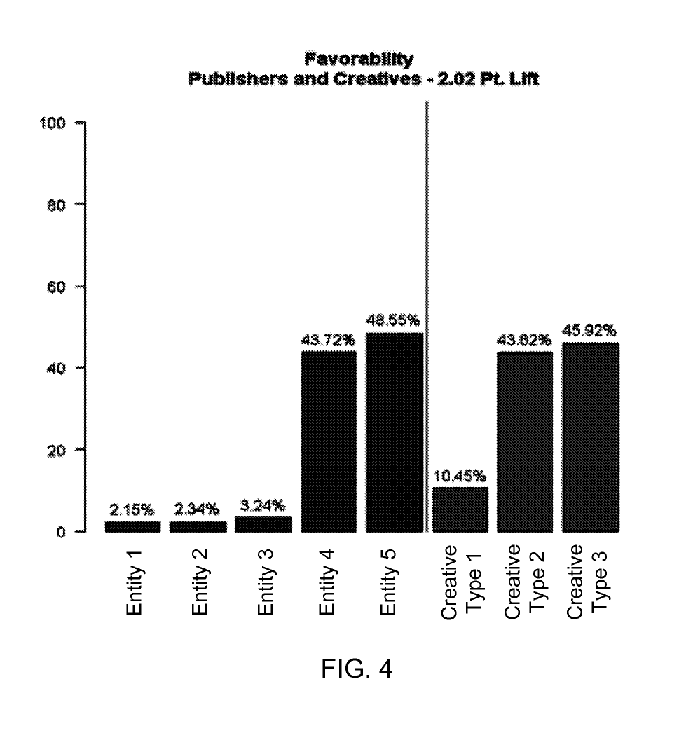

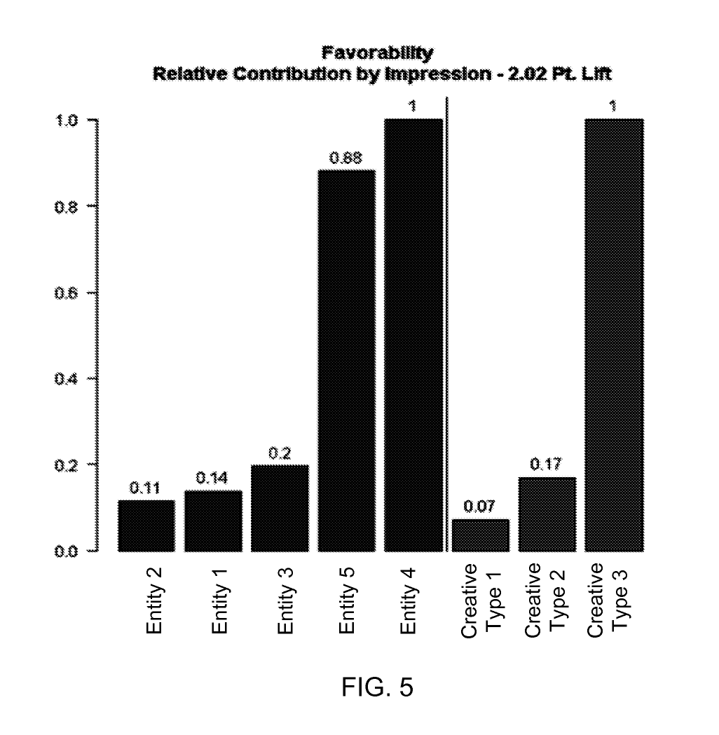

FIGS. 4 and 5 are bar graphs illustrating examples of effectiveness metrics. The graphs illustrate metrics for an advertising campaign for different publishers (or entities) and for different types of creatives.

The graph of FIG. 4 illustrates aggregate contributions for entities and creative types in the advertising campaign. With this metric, advertisements of creative type 2 and creative type 3 appear to perform similarly, each contributing slightly less than half of the total effect of the campaign.

The graph of FIG. 5 illustrates relative contribution metrics for publishers and creative types on a per-impression basis. The values indicate the incremental increase in probability of an outcome measure due to a single exposure to a user. The levels are also normalized, with the most effective entity or creative type designated as a baseline value of 1.0.

Although creative type 2 and creative type 3 had similar proportions of the total effect of the campaign (see FIG. 4), the graph of FIG. 5 illustrates that on a per-exposure basis, creative type 3 is much more effective than creative type 2.

Referring again to FIG. 3, in some implementations, the generated model may be, rather than a Probit regression model, a more generalized regression model. For example, a logistic regression model may be used to determine the probability of a positive consumer response in view of factors discussed above, including the number of exposures to each creative and each publisher, age, gender, income level, and usage of the brand, product, or service. In general, a logistic regression model is based on the logistic function:

$$f ( z ) = \frac{{e}^{z}}{{e}^{z} + 1} = \frac{1}{1 + {e}^{- z}}$$

$$with$$

$$z = {β}_{0} + {β}_{1} {x}_{1} + {β}_{2} {x}_{2} + {β}_{3} {x}_{3} + … + {β}_{k} {x}_{k} ,$$

where f(z) is the probability of a particular outcome (e.g., a positive consumer response), where β₀ is a constant (sometimes referred to as the “intercept”) and β₁, β₂, β₃, and so on, are called the “regression coefficients” of the factors x₁, x₂, x₃ respectively.

Markov Model Monte Carlo (MCMC) Bayesian Estimation may be applied to the measurement data to determine values of the coefficients in the logistic regression model. This data also may be analyzed to determine whether any and, if so, which factors do not affect the probabilities of a positive consumer response. The regression coefficients for those factors that do not affect the probability of a positive consumer response may be set to zero and the regression coefficients for the other factors may be set to the values determined by the MCMC Bayesian Estimation.

Unlike prior approaches that, for example, attribute all of the branding effect to the publisher or creative associated with a survey research respondent's last exposure to the creative prior to taking the survey, the system, the components, the processes, and the models described herein may account for all of a respondent's exposures to creatives across all publishers, including those exposures that occur prior to and following a survey experience. As a result, the metrics generated may reflect the composite effects of an entire campaign rather than a survey-only view. Being able to capture a complete view of creative exposures allows for informed attribution to a publisher and advertising creative as well as accurate, holistic campaign measurement.

As a result, the systems, the components, the processes, and the models described herein have advantages over prior approaches. For example, the systems, the components, the processes, and the models described herein may accounts for all exposures, including those prior to, and following, a survey experience allowing accurate, holistic campaign measurement and proper attribution by publisher and creative. In addition, the systems, the components, the processes, and the models described herein may account not only for exposures delivered until the point in time a survey was taken, but also throughout the duration of the campaign. Therefore, metrics generated reflect the true effects of an entire campaign rather than a survey-only view. The systems, the components, the processes, and the models described herein also allow for a more granular analysis of data than other market solutions, providing more actionable and valuable results. For example, the systems, the components, the processes, and the models can generate advertising exposure impacts by publisher or publisher type, demographic groups, interest segments, audience segments from third-party data providers, creative type, creative placements and client-defined segments, among others.

The techniques can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processing devices executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processing devices suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer also will include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, useful results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A computer-implemented method comprising:
accessing measurement data associated with a group of consumers that have been exposed to at least one advertising creative that is part of an advertising campaign, the measurement data indicating exposure levels for one or more campaign elements associated with the advertising campaign and indicating one or more consumer responses;
generating a model based on the accessed measurement data, wherein the model relates probabilities of a positive consumer response to exposure levels for the one or more campaign elements;
determining, using the model, a change in a probability of a positive consumer response attributable to the one or more campaign elements; and
determining an advertising effectiveness metric based on the determined change in the probability of the positive consumer response.

2. The method of claim 1 wherein the advertising effectiveness metric indicates the contribution of the one or more elements of the campaign to an overall effectiveness of the campaign.

3. The method of claim 1 wherein the one or more campaign elements comprise a plurality of different campaign elements.

4. The method of claim 3 wherein the plurality of different campaign elements comprises different creatives and different publishers.

5. The method of claim 3 wherein determining, using the model, a change in a probability of a positive consumer response attributable to the one or more elements of the campaign comprises determining a portion of an overall advertising effectiveness of the campaign that is attributable to the one or more campaign elements.

6. The method of claim 3 wherein determining, using the model, a change in a probability of a positive consumer response attributable to the one or more campaign elements comprises determining a change in a probability of a positive consumer response attributable to exposure to a combination of campaign elements.

7. The method of claim 3 wherein determining an advertising effectiveness metric based on the determined change in the probability of the positive consumer response measure comprises determining an advertising effectiveness metric indicating an advertising effectiveness attributable to a campaign element or a group of campaign elements.

8. The method of claim 3 wherein determining an advertising effectiveness metric based on the determined change in the probability of the positive consumer response measure comprises determining an advertising effectiveness metric indicating an advertising effectiveness of a first one of the campaign elements relative to an advertising effectiveness of a second, different one of the campaign elements.

9. The method of claim 1 wherein the model further relates probabilities of a positive consumer response to consumer attributes, and
wherein determining, using the model, a change in a probability of a positive consumer response attributable to the one or more campaign elements comprises determining a change in probability due to the one or more campaign elements and not due to consumer attributes.

10. The method of claim 1 wherein the one or more exposure levels comprise at least one exposure level for each consumer of the group of consumers, and the one or more consumer responses comprise at least one consumer response for each consumers of the group of consumers.

11. The method of claim 10 wherein the one or more exposure levels each indicate individual exposures of a creative in the campaign to a consumer.

12. The method of claim 1 wherein determining an advertising effectiveness metric based on the determined change in the probability of the positive consumer response measure and the accessed measurement data comprises:
accessing panel data that indicates exposures of a panel of users to the advertising campaign;
projecting the panel data to a population exposed to the campaign to generate projected exposure data; and
determining an advertising effectiveness metric based on the determined change in the probability of the positive consumer response measure and the projected exposure data.

13. The method of claim 1 wherein determining an advertising effectiveness metric based on the determined change in the probability of the positive consumer response measure and the accessed measurement data comprises determining the advertising effectiveness metric based on advertising exposures for which no subsequent consumer responses are available.

14. The method of claim 1 wherein generating a model based on the accessed measurement data comprises generating a model based on the accessed measurement data such that the one or more consumer responses indicated by the measurement data are related to a plurality of exposures that are indicated by the measurement data to have occurred prior to the corresponding consumer responses.

15. A system comprising:
one or more processing devices;
one or more storage devices storing instructions that, when executed by the one or more processing devices, causes the one or more processing devices to:
access measurement data associated with a group of consumers that have been exposed to at least one advertising creative that is part of an advertising campaign, the measurement data indicating exposure levels for one or more campaign elements associated with the advertising campaign and indicating one or more consumer responses;
generate a model based on the accessed measurement data, wherein the model relates probabilities of a positive consumer response to exposure levels for the one or more campaign elements;
determine, using the model, a change in a probability of a positive consumer response attributable to the one or more campaign elements; and
determine an advertising effectiveness metric based on the determined change in the probability of the positive consumer response.

16. The system of claim 15 wherein the advertising effectiveness metric indicates the contribution of the one or more elements of the campaign to an overall effectiveness of the campaign.

17. The system of claim 15 wherein the one or more campaign elements comprise a plurality of different campaign elements.

18. The system of claim 17 wherein the plurality of different campaign elements comprises different creatives and different publishers.

19. The system of claim 17 wherein, to determine the change in the probability of a positive consumer response, the instructions include instructions that, when executed by the one or more processing devices, cause the one or more processing devices to determine a portion of an overall advertising effectiveness of the campaign that is attributable to the one or more campaign elements.

20. The system of claim 17 wherein, to determine the change in the probability of a positive consumer response, the instructions include instructions that, when executed by the one or more processing devices, cause the one or more processing devices to determine a change in a probability of a positive consumer response attributable to exposure to a combination of campaign elements.

21. The system of claim 17 wherein, to determine the advertising effectiveness metric, the instructions include instructions that, when executed by the one or more processing devices, cause the one or more processing devices to determine an advertising effectiveness metric indicating an advertising effectiveness attributable to a campaign element or a group of campaign elements.

22. The system of claim 17 wherein, to determine the advertising effectiveness metric, the instructions include instructions that, when executed by the one or more processing devices, cause the one or more processing devices to determine an advertising effectiveness metric indicating an advertising effectiveness of a first one of the campaign elements relative to an advertising effectiveness of a second, different one of the campaign elements.

23. The system of claim 17 wherein the model further relates probabilities of a positive consumer response to consumer attributes, and
wherein to determine the change in the probability of a positive consumer response, the instructions include instructions that, when executed by the one or more processing devices, cause the one or more processing devices to determine a change in the probability of a positive consumer response due to the one or more campaign elements and not due to the consumer attributes.

24. The system of claim 15 wherein the one or more exposure levels comprise at least one exposure level for each consumer of the group of consumers, and the one or more consumer responses comprise at least one consumer response for each consumers of the group of consumers.

25. The system of claim 24 wherein the one or more exposure levels each indicate individual exposures of a creative in the campaign to a consumer.

26. The system of claim 15 wherein to determine the advertising effectiveness metric, the instructions include instructions that, when executed by the one or more processing devices, cause the one or more processing devices to:
access panel data that indicates exposures of a panel of users to the advertising campaign;
project the panel data to a population exposed to the campaign to generate projected exposure data; and
determine the advertising effectiveness metric based on the determined change in the probability of the positive consumer response measure and the projected exposure data.

27. The system of claim 15 wherein, to determine an advertising effectiveness metric the instructions include instructions that, when executed by the one or more processing devices, cause the one or more processing devices to determine the advertising effectiveness metric based on advertising exposures for which no subsequent consumer responses are available.

28. The system of claim 15 wherein, to generate a model based on the accessed measurement data, the instructions include instructions that, when executed by the one or more processing devices, cause the one or more processing devices to generate a model based on the accessed measurement data such that the one or more consumer responses indicated by the measurement data are related to a plurality of exposures that are indicated by the measurement data to have occurred prior to the corresponding consumer responses.
